(19) United States
(12) Patent Application Publication
(10) Pub. No.: US 2010/0083316 A1
(43) Pub. Date: Apr. 1, 2010

(54) Electronic Apparatus and Electronic Program Guide Display Method

(75) Inventors: Yuuichi Togashi, Suginami-ku (JP); Masafumi Tamura, Chofu-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/480,489

(22) Filed: Jun. 8, 2009

(30) Foreign Application Priority Data
Sep. 29, 2008 (JP) 2008-251723

(51) Int. Cl. H04N 5/445

(52) U.S. Cl. 725/41; 725/47

(57) ABSTRACT

According to an aspect of the invention, an electronic apparatus includes: an electronic program guide (EPG) information receiver configured to receive EPG information; and an EPG generating module configured to generate an EPG display image based on the EPG information, wherein the EPG display image has a plurality of frames corresponding to channels, the frames being arranged in transverse and depth directions of the EPG display image and containing a thumbnail image and program information corresponding to the respective channels of the frame.

### CROSS-REFERENCE TO RELATED APPLICATIONS

This application is based upon and claims the benefit of priority from Japanese Patent Application No. 2008-251723, filed Sep. 29, 2008, the entire contents of which are incorporated herein by reference.

### BACKGROUND

1. Field

The present invention relates to an electronic apparatus and an electronic program guide (EPG) display method.

2. Description of the Related Art

In recent years, the number of channels which can be viewed at home has been increased. For this reason, a range of a selection for a program to be broadcast has been enlarged rapidly. On the other hand, due to the enlargement of the range of the selection, it is very hard to know which program is broadcast through any channel.

Therefore, there have been invented a large number of mechanisms capable of acquiring an EPG which is offered from a broadcast wave or a network and selecting a program easily based on the EPG.

For example, an EPG offering system described in JP-A-2003-169312 is constituted to have a broadcasting station for offering a video content, an index creating station for creating an index for the video content offered from the broadcasting station, a digest video creating station for creating a digest video based on the video content acquired from the broadcasting station and the index acquired from the index creating station, and an EPG offering station for offering, to a user side, an EPG to which the digest video is attached or which is linked to the digest video based on a schedule for a broadcast program which is acquired from the broadcasting station and the digest video acquired from the digest video creating station.

A user can know the contents of the video content to select a program by acquiring the EPG including the digest video provided from the EPG offering station or a link to the digest video.

For example, according to a digital home communication terminal described in Japanese Patent No. 3805253, four videos having EPG information in a lower part are displayed on a display screen.

The user can effectively switch a plurality of channels based on the displayed videos and the EPG information.

For example, according to a receiver described in JP-A-2008-28602, channel numbers, program names which correspond thereto, and small screens for displaying motion picture or still picture of the corresponding program to the channel number are displayed on a program selecting screen corresponding to a plurality of channels. An empty tuner is periodically assigned to each of the small screens and a motion picture of a corresponding program to each channel number is cyclically displayed.

The user selects a program while seeing the small screen. Therefore, it is possible to implement a program selecting environment which can easily be known visually.

For example, according to a channel navigation device described in JP-A-11-122555, a tuner is controlled by means of a tuner controller for a navigation, video signals of channels to be sequentially searched are successively transmitted to a computer graphic portion through an image processing module, and an image processing to turn over pages of a book in the computer graphic portion is carried out, and furthermore, videos are displayed on a screen in a half of a display in combination with EPG data.

The user can select a desirable program by operating an image like turning over pages, the image having a motion picture and the EPG data combined with each other.

However, the EPG offering system described in JP-A-2003-169312 has a technique related to the EPG offered to a user and does not have a technique for setting the currently offered EPG to have a high convenience through a receiver on the user side. For this reason, there is a disadvantage in that the same system cannot be utilized until basic facilities such as a digest creating station are arranged.

Referring to the digital home communication terminal described in Japanese Patent No. 3805253, when there are a large number of channels in different broadcasting formats, for example, digital terrestrial broadcasting, a BS (Broadcasting Satellite) digital broadcast and a CS (Communications Satellite) digital broadcast, it is hard to efficiently select a desirable program therefrom and a video and EPG information are displayed on a whole display screen. For this reason, the digital home communication terminal is not suitable for selecting the program while seeing a program which is being viewed.

Referring to the receiver described in JP-A-2008-28602, moreover, information displayed on the program selecting screen is lessened. For this reason, there is a disadvantage in that it is hard to know which program can be viewed at a different broadcast time.

Referring to the channel navigation device described in JP-A-11-122555, furthermore, it is hard to find a desirable program from a large number of channels because a screen imitates a book.

### SUMMARY OF THE INVENTION

According to an aspect of the present invention, there is provided an electronic apparatus including: an electronic program guide (EPG) information receiver configured to receive EPG information; and an EPG generating module configured to generate an EPG display image based on the EPG information, wherein the EPG display image has a plurality of frames corresponding to channels, the frames being arranged in transverse and depth directions of the EPG display image and containing a thumbnail image and program information corresponding to the respective channels of the frame.

According to another aspect of the present invention, there is provided an electronic program guide (EPG) display method including: receiving EPG information; generating an EPG display image based on the EPG information, the EPG display image having a plurality of frames corresponding to channels, the frames being arranged in transverse and depth directions of the EPG display image and containing a thumbnail image and program information corresponding to the respective channels of the frame; displaying the EPG display image on a display screen with channel names when a first instruction is input; enlarging a display region of the EPG display image on the display screen when a second instruction is input so as to display the program information about a subsequent time from the program information displayed by the first instruction.

According to another aspect of the present invention, there is provided an electronic apparatus including: a user interface module; an electronic program guide (EPG) information receiver configured to receive EPG information; and an EPG generating module configured to generate an EPG display image based on the EPG information, wherein the EPG display image has a plurality of frames corresponding to channels, the frames being arranged in transverse and depth directions of the EPG display image and containing a thumbnail image and program information corresponding to the respective channels of the frame, wherein the EPG generating module is configured to control the EPG display image to be displayed on a display screen with channel names according to a first instruction input through the user interface module, wherein the EPG generating module is configured to enlarge a display region of the EPG display image on the display screen according to a second instruction input through the user interface module so as to display the program information about a subsequent time from the program information displayed by the first instruction, and wherein the frames are categorized in the depth direction by broadcasting formats, wherein the EPG generating module is configured to make the EPG display image displayed on the display screen into birds-eye view according to a third instruction input through the user interface module.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic perspective view showing an outer appearance of a digital television according to an embodiment of the invention,

FIG. 2 is an exemplary block diagram showing a structure of the digital television according to the embodiment,

FIG. 3 is an exemplary schematic view showing a remote controller according to the embodiment,

FIG. 4 is an exemplary schematic view showing a display screen on which an electronic program guide (EPG) is displayed according to the embodiment,

FIG. 5 is an exemplary schematic view showing the display screen on which an EPG in a different broadcasting format is displayed according to the embodiment,

FIG. 6 is an exemplary schematic view showing the display screen on which an EPG related to a BS digital broadcast is selected according to the embodiment,

FIG. 7 is an exemplary schematic view showing the display screen on which an EPG related to a CS digital broadcast is selected according to the embodiment,

FIG. 8 is an exemplary schematic view showing the display screen over which a display instruction for enlarging the display of the EPG is selected according to the embodiment,

FIG. 9 is an exemplary schematic view illustrating a progress in the enlargement of the display of the EPG according to the embodiment,

FIG. 10 is an exemplary schematic view showing the display screen on which the display of the EPG is enlarged according to the embodiment, and

FIG. 11 is an exemplary flowchart related to a creation and display of the EPG according to the embodiment.

### DETAILED DESCRIPTION

An embodiment of an electronic apparatus and an electronic program guide display method according to the invention will be described below in detail with reference to the drawings.

### Embodiment

### Structure of Digital Television

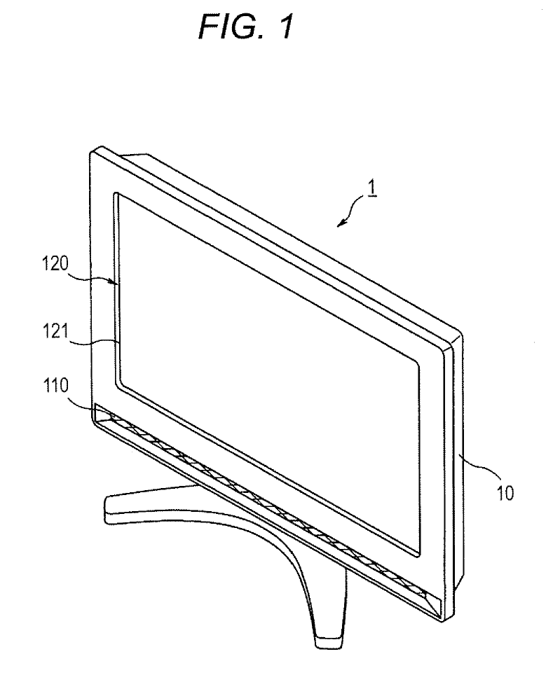

FIG. 1 is a schematic perspective view showing an outer appearance of a digital television according to the embodiment of the invention. Although description will be given to the case in which the electronic apparatus according to the invention is provided on the digital television in the embodiment, the invention is not restricted thereto but can be used in a broadcast receiving device, a portable telephone having a broadcast receiving function, and a video recording apparatus provided with the broadcast receiving device, and furthermore, can also be used in a broadcast receiving device capable of receiving a program delivered from a broadcasting station through a network and a PC (Personal Computer) and the invention is not restricted thereto.

As an example, a digital television 1 has a body 10 for storing electronic devices such as a tuner, an audio amplifier and a signal processing module which will be described below, a display portion 120 constituted by an LCD (Liquid Crystal Display), and a speaker 110 for outputting a voice. The digital television 1 acquires a power from an outside through a plug which is not shown, receives a digital terrestrial broadcasting wave through an antenna which will be described below, and decodes, through the signal processing module, a signal of the digital terrestrial broadcasting wave thus received, thereby outputting a video signal and an audio signal. The display portion 120 processes the video signal thus decoded and displays a video. The speaker 110 processes the audio signal thus decoded and outputs a voice.

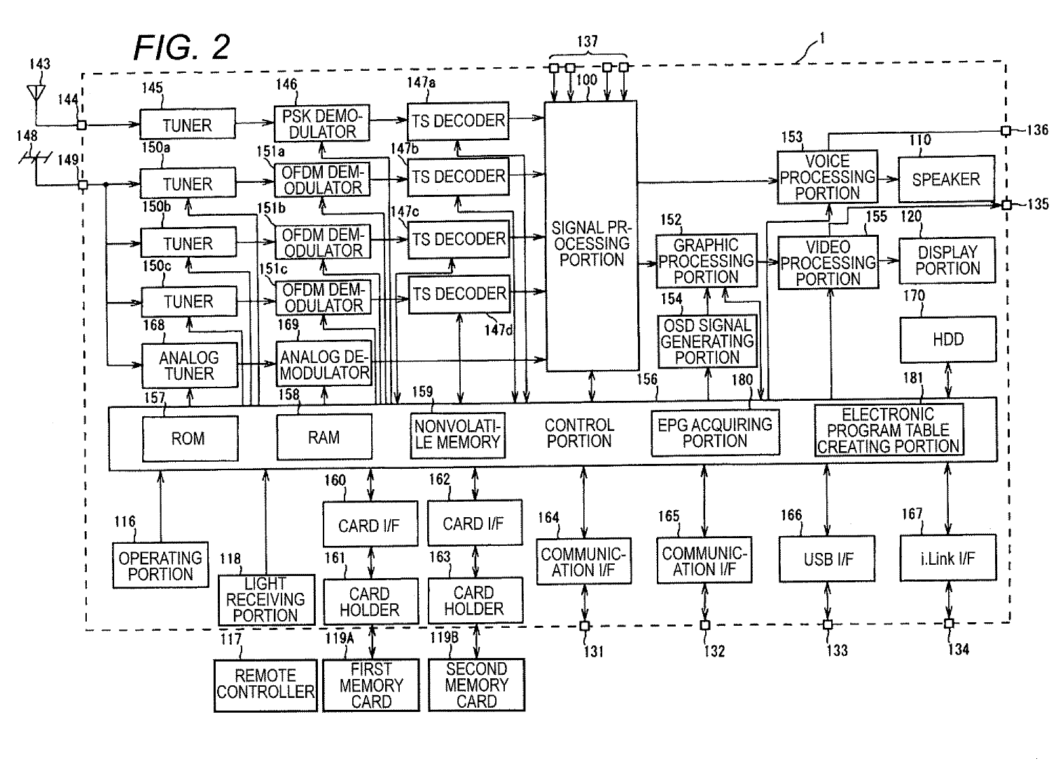

FIG. 2 is a block diagram showing a structure of the digital television according to the embodiment of the invention.

The digital television 1 includes a control module 156 for controlling an operation of each portion in the device. The control module 156 includes a CPU (Central Processing Unit). The control module 156 starts a system control program and various processing programs which are stored beforehand in an ROM (Read Only Memory) 157 in response to an operating signal input from a user interface module 116 and an operating signal transmitted from a remote controller 117 and received through a light receiving module 118. The control module 156 sets an RAM (Random Access Memory) 158 as a work memory in accordance with the started programs and controls the operation of each portion in the device. Various set information and control information for controlling the operation of each portion are stored in a nonvolatile memory 159 as an example, and furthermore, the control module 156 has an EPG information acquiring portion (an EPG information acquiring portion) 180 and an EPG generating portion 181 which will be described below.

As an example, moreover, the digital television 1 is constituted to receive a ground wave analog broadcast, a digital terrestrial broadcasting, a BS digital broadcast and a CS digital broadcast as broadcasting formats, and furthermore, includes an HDD (Hard Disk Drive) 170 capable of recording programs supplied therefrom and storing an acquired EPG information which will be described below.

A BS/CS digital broadcast receiving antenna 143 receives a satellite digital television broadcasting signal. The digital broadcasting signal thus received is supplied to a satellite digital broadcasting tuner 145 through an input terminal 144. The tuner 145 carries out tuning for the received digital broadcasting signal and transmits the digital broadcasting signal subjected to the tuning to a PSK (Phase Shift Keying) demodulator 146. The PSK demodulator 146 carries out a demodulation for a TS (Transport Stream) and supplies the demodulated TS to a TS decoder 147a, and the TS decoder 147a decodes the TS into a digital video signal and an audio signal and then outputs them to a signal processing module 100.

A digital terrestrial broadcasting receiving antenna 148 has three tuners 150a, 150b and 150c for receiving a ground wave digital television broadcasting signal. The digital broadcasting signals thus received are supplied to the digital terrestrial broadcasting tuners 150a, 150b and 150c through an input terminal 149. The tuners 150a, 150b and 150c carry out tuning over the received digital broadcasting signals and transmit the digital broadcasting signals subjected to the tuning to respective OFDMs (Orthogonal Frequency Division multiplexing) demodulators 151a, 151b and 151c. The OFDM demodulators 151a, 151b and 151c demodulate the TS and supply the demodulated TS to respective TS decoders 147b, 147c and 147d, and the TS decoders 147b, 147c and 147d decode the TS into a digital video signal and an audio signal and then output them to the signal processing module 100.

The antenna 148 can also receive a ground wave analog broadcasting signal. The ground wave analog broadcasting signal thus received is distributed by a distributor which is not shown and is supplied to an analog tuner 168. The analog tuner 168 carries out tuning for the analog broadcasting signal which is received and transmits, to an analog demodulator 169, the analog broadcasting signal subjected to the tuning. The analog demodulator 169 demodulates the analog broadcasting signal and outputs the analog broadcasting signal thus demodulated to the signal processing module 100. Through the digital television 1, moreover, it is also possible to view a CATV (Common Antenna Television) by a connection of a tuner for the CATV to the input terminal 149 to which the antenna 148 is connected as an example.

The signal processing module 100 carries out a proper digital signal processing over the digital broadcasting signals output from the TS decoders 147a to 147d. The digital broadcasting signals are separated into a data signal, a video signal and an audio signal. The video and audio signals obtained by the separation are output to a graphic processing module 152 and a voice processing module 153, respectively. The signal processing module 100 converts a broadcasting signal output from the analog demodulator 169 into digital video and audio signals in predetermined formats. The video and audio signals converted digitally are output to the graphic processing module 152 and the voice processing module 153, respectively. Moreover, the signal processing module 100 also carries out a predetermined digital signal processing over a signal input from a line input terminal 137.

An OSD (On Screen Display) signal generating portion 154 generates an OSD signal for displaying a UI (user interface) screen in accordance with a control of the control module 156. In the signal processing module 100, moreover, the data signal separated from the digital broadcasting signal is converted into an OSD signal in a proper format through the OSD signal generating module 154 and outputs the OSD signal to the graphic processing module 152. Furthermore, the OSD signal generating module 154 receives an EPG signal for displaying an EPG created by the EPG generating portion 181 which will be described below and synthesizes the EPG signal with the UI screen or an image of a program which is being viewed, and outputs the synthesized signal to the graphic processing module 152.

The graphic processing module 152 carries out a decode processing for the digital video signal output from the signal processing module 100. The video signal thus decoded is transmitted to the EPG generating portion 181 in order to create a thumbnail of an EPG which will be described below. Moreover, the video signal thus decoded is superposed on and synthesized with the OSD signal output from the OSD signal generating module 154, and outputs a signal thus obtained to a video processing module 155. The graphic processing module 152 can also output the decoded video signal or the OSD signal to the video processing module 155 selectively. Moreover, the video signal and the OSD signal can also be output in combination to constitute a half of the screen, respectively.

The video processing module 155 converts the signal output from the graphic processing module 152 into an analog video signal in a format which can be displayed by the display portion 120. The video signal converted into the analog signal is output to the display portion 120 and is displayed on a display screen 121. Moreover, the video processing module 155 can output a video signal to an external device such as an HOD recorder connected to an external output terminal 135.

The voice processing module 153 converts the input audio signal into an analog audio signal in a format which can be reproduced by the speaker 110. The audio signal converted into the analog audio signal is output to the speaker 110 and is thus reproduced. Moreover, the voice processing module 153 can output the audio signal to an external device such as an amplifier which is connected to an external output terminal 136.

A card holder 161 is connected to the control module 156 through a card I/F (Interface) 160. A first memory card 119A can be attached to the card I/F 160. The first memory card 119A is a storage medium such as an SD (Secure Digital) memory card, an MMC (Multimedia Card) and a CF (Compact Flash) card. The first memory card 119A attached to the card holder 161 and the control module 156 can transmit information through the card I/F 160. The control module 156 can store data such as an image, a music and a broadcast program in the first memory card 119A. Moreover, the control module 156 can read data such as the image, the music and the broadcast program which are stored in the first memory card 119A and can display the data on the display portion 120 or can output a voice from the speaker 110.

A card holder 163 is connected to the control module 156 through a card I/F 162. A second memory card 119B can be attached to the card I/F 162. The second memory card 119B is a storage medium for storing contract information about a broadcast receiving contract, for example. The second memory card 119B attached to the card holder 163 and the control module 156 can transmit information through the card I/F 160.

A first LAN (Local Area Network) terminal 131 is connected to the control module 156 through a communication I/F 164. The first LAN terminal 131 is utilized as an LAN compatible HOD dedicated port using Ethernet (registered trademark). In the case in which an LAN compatible HOD is connected as an NAS (Network Attached Storage) to the first LAN terminal 131, the HDD and the control module 156 can transmit information through the communication I/F 164. In this case, the control module 156 functions as a DHCP (Dynamic Host Configuration Protocol) server and assigns an IP (Internet Protocol) address to the LAN compatible HDD connected to the first LAN terminal 131 and carries out a control.

The control module 156 can store the data such as the image, the music and the broadcast program in the HDD. Moreover, the control module 156 can read the data such as the image, the music and the broadcast program stored in the HDD and can display the data on the display portion 120 or can output a voice from the speaker 110. By providing the first LAN terminal 131 as the LAN compatible HDD dedicated port, it is possible to stably record information about a program through high-definition television image quality in the HDD without an influence of other network environments or network using situations.

A second LAN terminal 132 is connected to the control module 156 through a communication I/F 165. The second LAN terminal 132 is utilized as a general LAN compatible port using the Ethernet (registered trademark). An apparatus such as an LAN compatible HDD, a PC (Personal Computer) or an HDD integrating DVD (Digital Versatile Disk) recorder is connected to the second LAN terminal 132 by using a hub, for example. The apparatus connected to the second LAN terminal 132 and the control module 156 can transmit information through the communication I/F 165. In the case in which a broadband router is connected to the second LAN terminal 132 through a hub, the control module 156 can be connected to a network such as Internet through the broadband router. A PC or a portable telephone is connected to the network and can transmit information together with the digital television 1.

A storage medium such as a hard disk or a DVD (an optical disk) can be attached to the apparatus such as the HDD, the PC or the DVD recorder connected to the control module 156 through the communication I/F 165. The control module 156 can store, in the storage medium, data such as an image, a music and a broadcast program through a hub or an apparatus connected to the hub. Moreover, the control module 156 can read the data such as the image, the music and the broadcast program which are stored in the storage medium and can display them on the display portion 120 or can output a voice from the speaker 110.

A USB (Universal Serial Bus) terminal 133 is connected to the control module 156 through a USB I/F 166. The USB terminal 133 is used as a general USB compatible port. A card reader/writer, an HOD and a keyboard for a portable telephone, a digital camera and various memory cards are connected to the USB terminal 133 through a hub, for example. The control module 156 can transmit information together with the apparatus connected through the USB terminal 133.

An i. Link terminal 134 is connected to the control module 156 through an i. Link I/F 167. For example, an AV-HDD or a D (Digital)-VHS (Video Home System) is serially connected to the i. Link terminal 134. The control module 156 can transmit information together with an apparatus to be connected through the i. Link terminal 134 and the i. Link I/F 167.

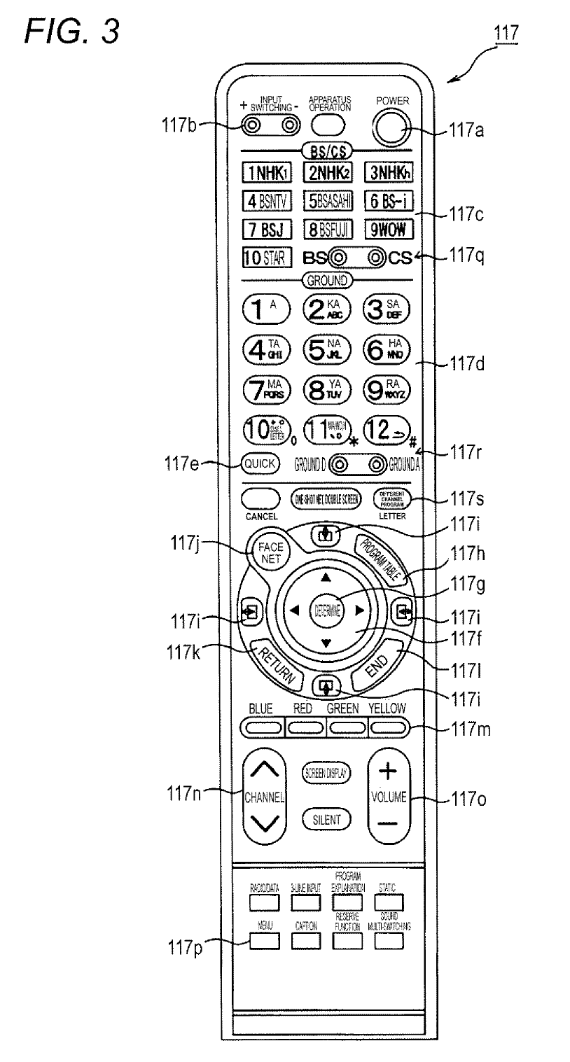

FIG. 3 is a schematic view showing a remote controller according to the embodiment of the invention. As shown in FIG. 3, the remote controller 117 is schematically constituted to mainly include a power key 117a, an input switching key 117b, a direct channel selecting key 117c for a satellite digital broadcast channel, a direct channel selecting key 117d for a ground wave broadcast channel, a quick key 117e, a cursor key 117f, a determination key 117g, an EPG key 117h, a page switching key 117i, a navigation key 117j, a return key 117k, an end key 117l, blue, red, green and yellow color keys 117m, a channel up-down key 117n, a volume control key 117o, a menu key 117p, a BS/CS switching key 117q, a ground wave digital/ground wave analog switching key 117r, and a different channel program key 117s.

### (Structure of EPG)

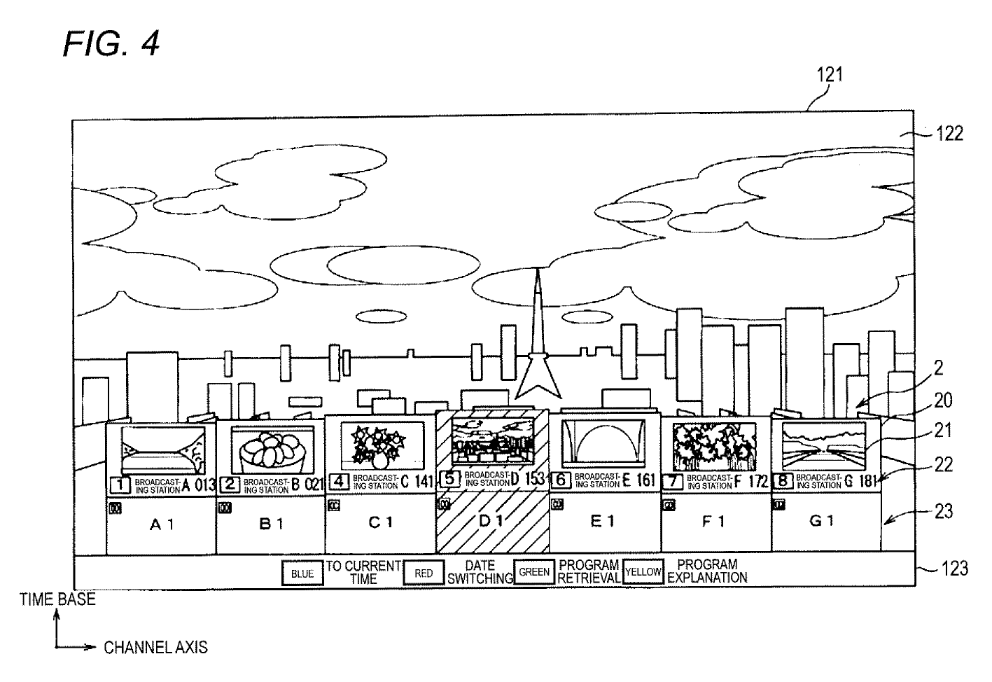

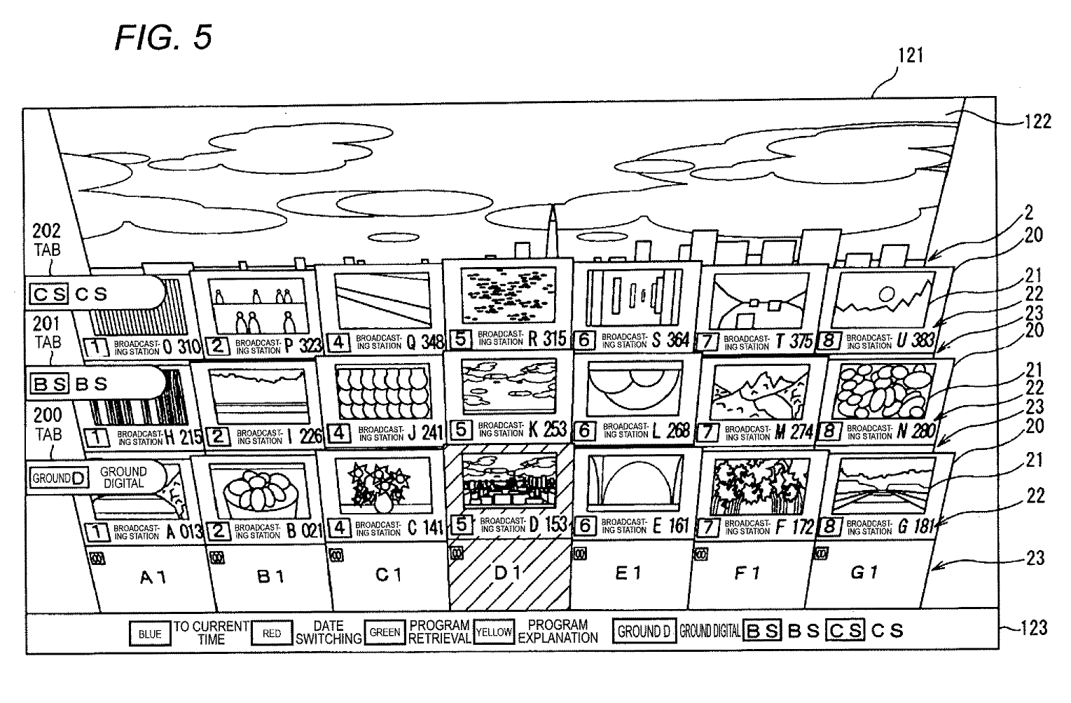

FIG. 4 is a schematic view showing a display screen on which an EPG is displayed according to the embodiment of the invention. FIG. 5 is a schematic view showing a display screen on which an EPG in a different broadcasting format is displayed according to the embodiment of the invention. FIG. 4 shows an initial display in a display of an EPG 2 on the display screen 121. In FIG. 4, a state in which the EPG 2 for a digital terrestrial broadcasting, a BS broadcast and a CS broadcast is seen from above is imitated and displayed on the display screen 121.

As an example, the EPG 2 for an initial display in accordance with a display instruction (a first display instruction) through the user interface module 116 or the EPG key 117h of the remote controller 117 has a channel axis in which a plurality of channels for a digital terrestrial broadcasting is arranged in a transverse direction and a time base in which a time is arranged in a longitudinal direction as shown in FIG. 4, and program information corresponding to a program column 23 specified by the time base and the channel axis (for example, A1, B1, C1, D1, E1, F1 and G1 shown in FIG. 3) corresponding to the program column 23 specified by the time axis and the channel axis is described and a thumbnail (a reduced image) 21 of a program for each broadcasting station (channel) which is being broadcast is displayed in a display region over a frame 20 for each broadcasting station (a frame for each channel) arranged along the channel axis. As an example, information about a summary of a program or a performer is described as character information in the program information.

As an example, the EPG 2 is displayed under the thumbnail 21 and includes a name of a broadcasting station and a broadcasting station display portion 22 indicative of an assigned numeral, and is arranged in a transverse direction in a lower part of the display screen 121 and hatching shown in FIG. 4 represents a state in which a broadcasting station D on a center is selected. The EPG 2 for the initial display is not restricted to the example but may be disposed in any region of the display screen 121.

Furthermore, the EPG 2 is formed to have the frame 20 for each broadcasting station which takes a shape of a card for each broadcasting station as an example, and a plurality of frames 20 for the broadcasting station is arranged concentrically and three-dimensionally for each broadcasting format. In the EPG 2, the frames 20 for the broadcasting station have a three-dimensional array. Therefore, program information in a large number of broadcasting stations can be seen from above at a time. The arranging method is not restricted thereto but may be arranged in parallel every broadcasting format, and furthermore, may be displayed on a side surface of a cylinder.

As an example, an operation guiding portion 123 is displayed in a lower part of the display screen 121 as shown in FIG. 4 and has a structure in which the EPG 2 for a current time, a window (not shown) for switching a date, a window (not shown) for retrieving a program and an explanation of a selected program can be displayed by pressing the blue, red, green and yellow keys in the color keys 117m of the remote controller 117 shown in FIG. 3, respectively.

The EPG 2 shown in FIG. 4 represents an EPG for a digital terrestrial broadcasting and is seen from a front around the selected broadcasting station D in the frames 20 for the broadcasting station which are arranged circumferentially.

The EPG 2 can be always scrolled laterally around a broadcasting station selected by the user interface module 116 or a manipulation of the cursor key 117f of the remote controller 117. In the EPG 2, the frames 20 for the broadcasting table are arranged circumferentially. Therefore, it is possible to see program information described in all of the frames 20 for the broadcasting station by carrying out a scroll in a single direction, for example.

The EPG 2 shown in FIG. 5 includes a plurality of EPGs for a digital terrestrial broadcasting, a BS digital broadcast and a CS digital broadcast which have different broadcasting formats, and a hidden EPG is displayed on the display screen 121 by the user interface module 116 or a manipulation of the different channel program key 117s of the remote controller 117 (a third display instruction). The EPG 2 represents a state in which the frame 20 for each broadcasting station arranged along a different circumference every broadcasting format is seen from above. Since the frame 20 for each broadcasting station and a display image 122 which are displayed on the display screen 121 are seen from above, they take trapezoidal shapes.

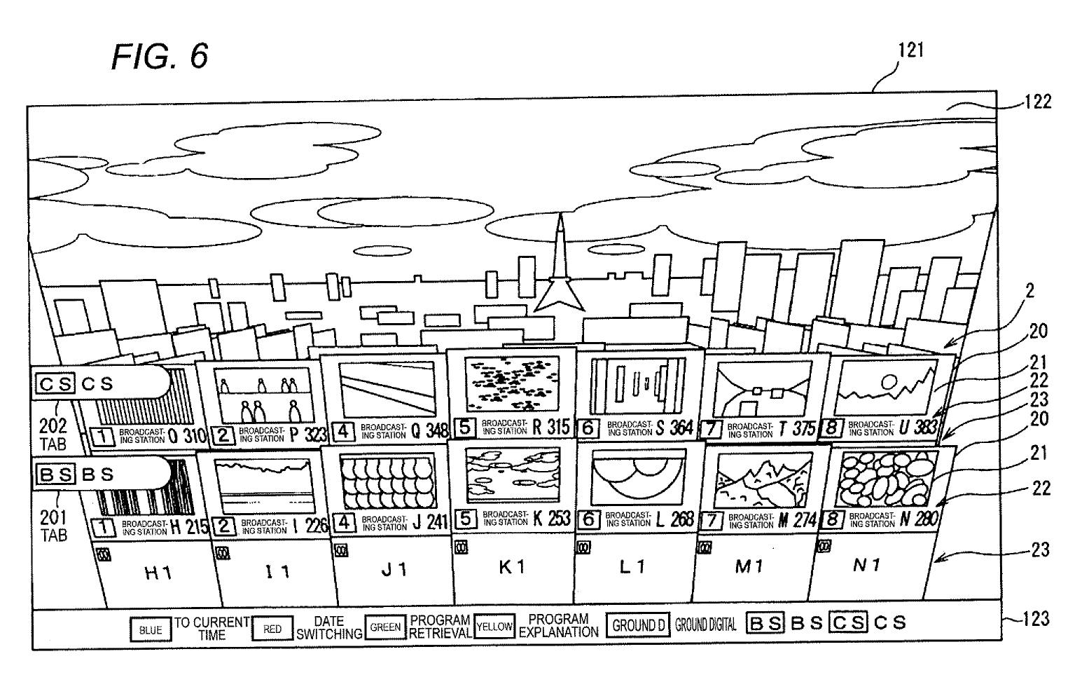

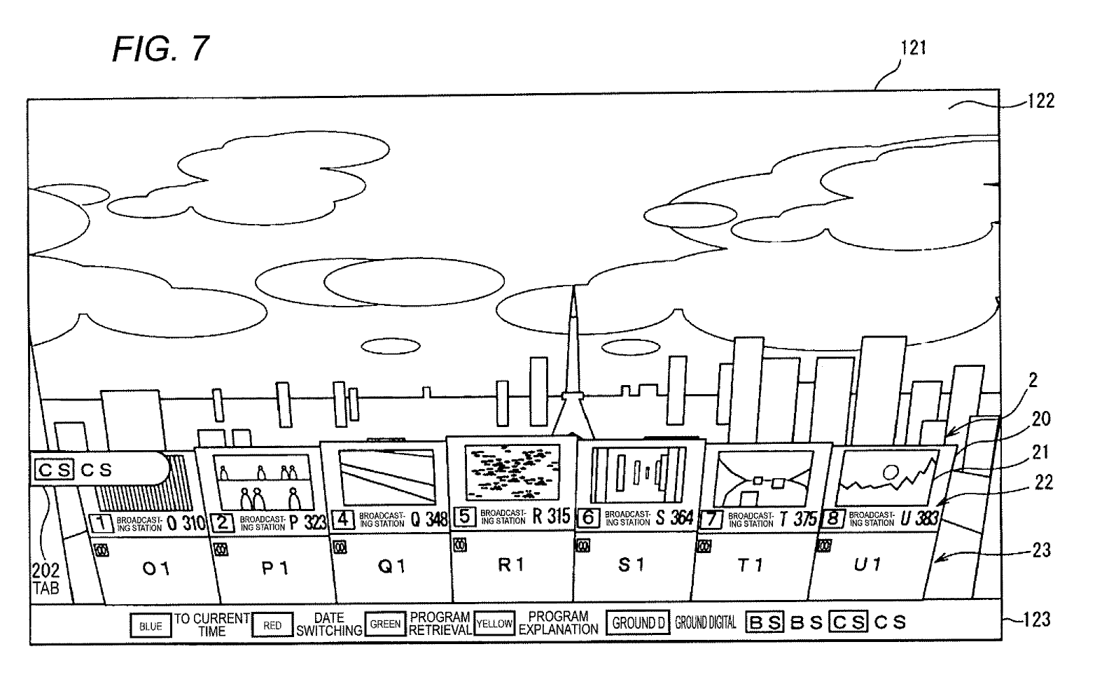

FIG. 6 is a schematic view showing a display screen in which an EPG related to a BS digital broadcast is selected according to the embodiment of the invention, and FIG. 7 is a schematic view showing a display screen in which an EPG related to a CS digital broadcast is selected according to the embodiment of the invention.

The operation guiding portion 123 shown in FIGS. 5 to 7 has a structure in which it is possible to display an EPG for a digital terrestrial broadcasting on a front surface as shown in FIG. 4 by pressing a ground wave digital side of the ground wave digital/ground wave analog switching key 117r of the remote controller 117, to display an EPG for a BS digital broadcast on the front surface as shown in FIG. 6 by pressing a BS side of the BS/CS switching key 117q, and to display an EPG for a CS digital broadcast on the front surface as shown in FIG. 7 by pressing a CS side of the BS/CS switching key 117q in addition to the manipulation through the blue, red, green and yellow keys of the color key 117m of the remote controller 117. Tabs 200 to 202 displayed on the display screen 121 indicate which broadcasting format is possessed by the arranged EPG.

### (Structure of EPG Acquiring Portion)

The EPG information acquiring portion 180 has a structure in which the EPG information is acquired from any of the digital terrestrial broadcasting, the ground wave analog broadcast and a network connected to the communication I/F 165 and is stored in the HDD 170 as an example.

The EPG information acquiring portion 180 is constituted to acquire the EPG through any of the digital terrestrial broadcasting, the ground wave analog broadcast and the network connected to the communication I/F 165 in a predetermine cycle after the digital television 1 is provided and various setting operations are then carried out as an example.

### (Structure of EPG Generating Portion)

The EPG generating portion 181 creates the EPG 2 shown in FIGS. 4 to 7 based on the EPG information acquired by the EPG information acquiring portion 180. More specifically, the EPG generating portion 181 creates the frame 20 for each broadcasting station every broadcasting format and broadcasting station and extracts, from the EPG, the contents described in the broadcasting station display portion 22 and the program column 23 which are provided in the frame 20 for each broadcasting station, and sticks the extracted contents in a predetermined format into a predetermined place.

Moreover, the EPG generating portion 181 creates the thumbnail 21 and sticks the thumbnail 21 onto the frame 20 for each broadcasting station of a corresponding broadcasting station. When creating the EPG 2 for the ground digital broadcast, the EPG generating portion 181 acquires an image of a program which is being broadcast in each broadcasting station displayed on the display screen 121 through the antenna 148, the tuners 150a to 150c, the OFDM demodulators 151a to 151c, the TS decoders 147b to 147d, the signal processing module 100 and the graphic processing module 152 and sticks the image as the thumbnail 21 onto the frame 20 for each broadcasting station, and transmits them as the EPG 2 to the OSD signal generating module 154 and displays, on the display portion 120, the EPG 2 together with an image of a program which is being viewed by a user.

The EPG generating portion 181 can display the thumbnail 21 setting, as a dynamic image for each broadcasting station, a program which is being broadcast when a tuner is provided for each broadcasting station in addition to a tuner to be used for viewing and a tuner to be used for recording, that is, the tuner is not used for the recording and the digital television 1 has eight tuners, eight OFDM demodulators and eight TS decoders for seven broadcasting stations of the ground digital broadcast shown in FIG. 4 and for viewing as an example.

When the digital television 1 does not have sufficient numbers of tuners, OFDM demodulators and TS decoders, moreover, the EPG generating portion 181 can acquire an image of a current program while taking a round for each broadcasting station based on a predetermined cycle and can stick the images as the thumbnail 21 onto the frame 20 for each broadcasting station of the corresponding broadcasting station in order as an example. When the EPG generating portion 181 does not have a sufficient number of tuners, moreover, a predetermined cycle may be set to be a little longer and a dynamic image may be displayed as the thumbnail 21 for a predetermined time in place of an image.

Similarly, the EPG generating portion 181 can stick, onto the frame 20 for each broadcasting station of the corresponding broadcasting station, the thumbnail 21 to be stuck into the EPG 2 for the BS digital broadcast and the CS digital broadcast as a dynamic image when a sufficient number of tuners are provided and as an image while taking a round based on a predetermined cycle when the sufficient number of tuners are not provided. When the EPG generating portion 181 does not have the sufficient number of tuners for the BS digital broadcast and the CS digital broadcast as described above, a predetermined cycle may be set to be a little longer and a dynamic image may be displayed as the thumbnail 21 for a predetermined time in place of an image. Thus, the EPG generating portion 181 can display, on the display screen 121, the EPG 2 displaying the thumbnail 21 of a program which is being broadcast.

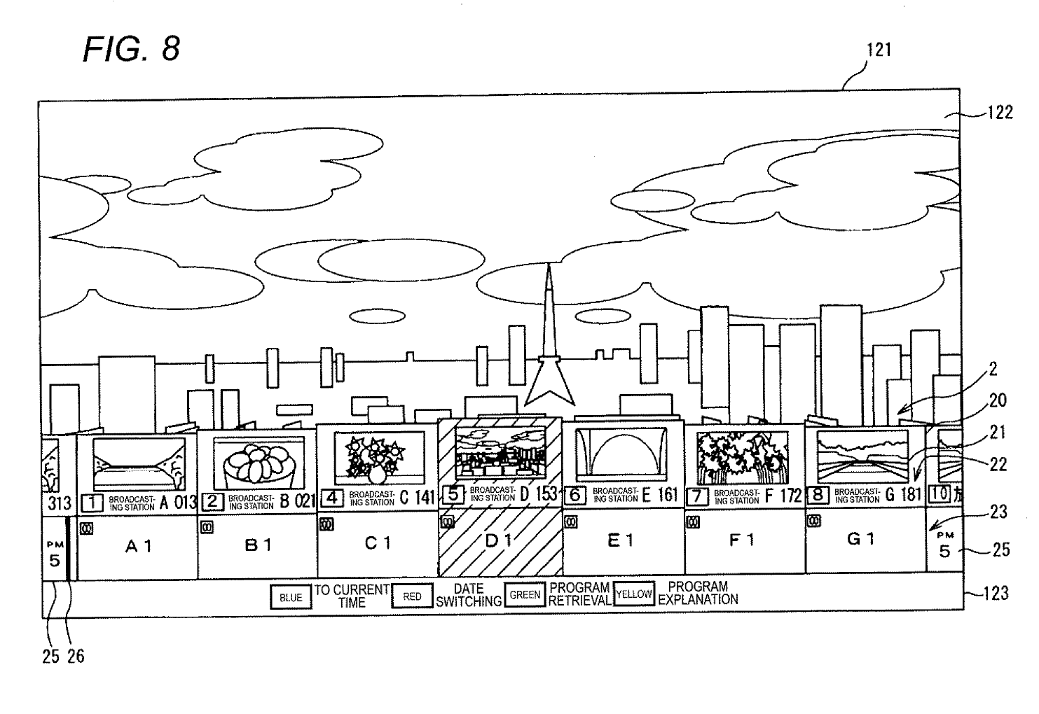

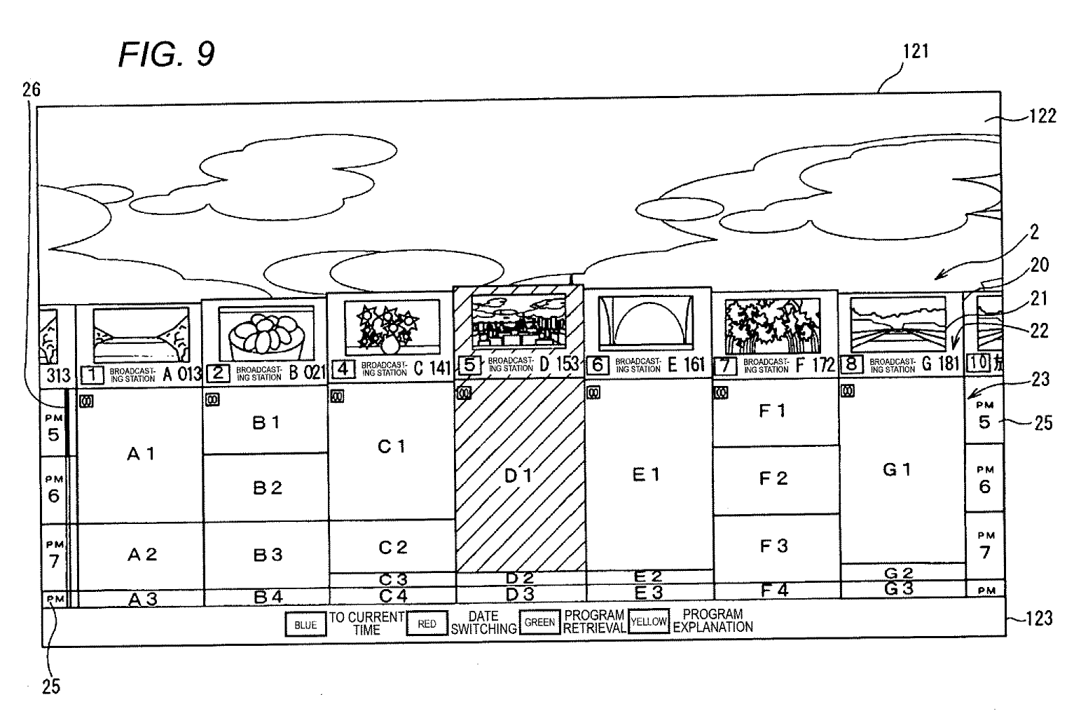

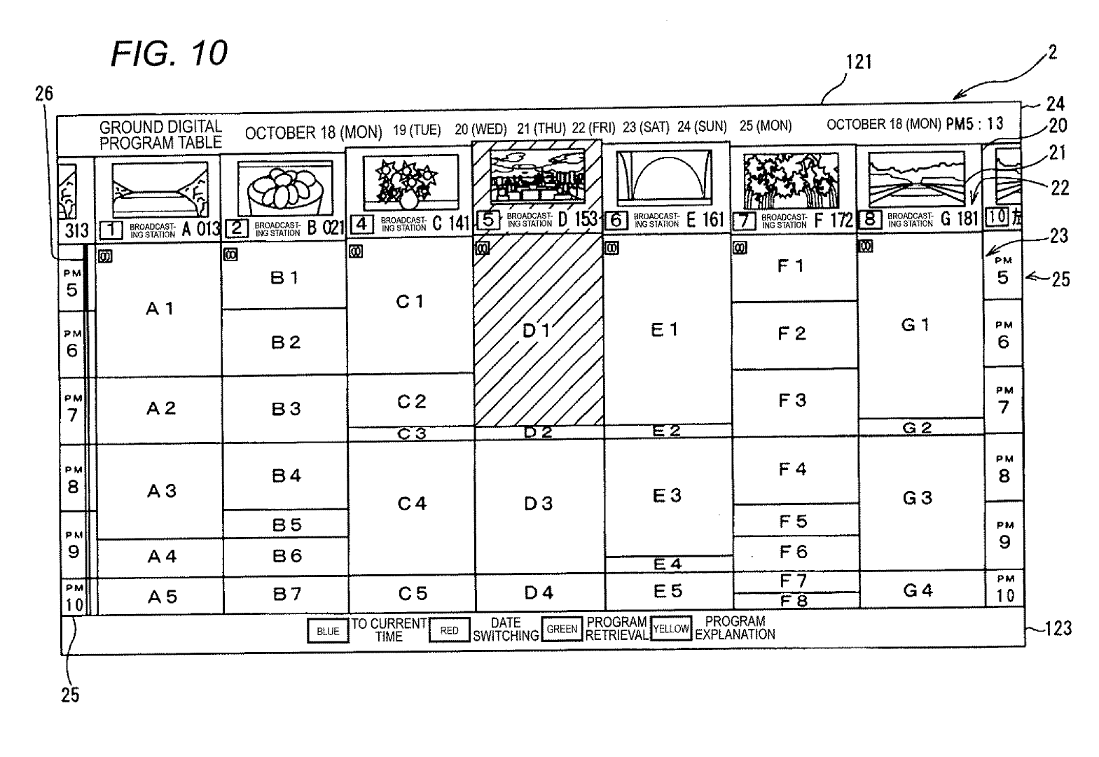

FIG. 8 is a schematic view showing the display screen in a selection of a display instruction for enlarging the display of the EPG according to the embodiment of the invention, FIG. 9 is a schematic view illustrating a process in which the display of the EPG is enlarged according to the embodiment of the invention, and FIG. 10 is a schematic view showing the display screen in the enlargement of the display of the EPG according to the embodiment of the invention.

As an example, the digital television 1 has a structure in which the EPG 2 for an initial display is displayed by the user interface module 116 or pressing the EPG key 117h of the remote controller 117, and furthermore, the initial display of the EPG 2 is enlarged to carry out a display on the whole display screen 121 by the user interface module 116 or pressing the EPG key 117h of the remote controller 117, that is, giving a second display instruction.

As an example, the EPG 2 thus enlarged is wholly displayed with the whole display screen 121 used as shown in FIG. 10, and a date display portion 24, a time display portion 25 and a current time bar 26 are further displayed and are created by the EPG generating portion 181.

The date display portion 24 is displayed on an upper part of the display screen 121, and a type of the EPG, a date of the EPG which is being displayed, a date of the week and a current date are displayed as an example.

As an example, the time display portion 25 is displayed on both sides of the display screen 121 and represents a time for the program column 23 which is being displayed.

The current time bar 26 is displayed on a current time when a time which is coincident with the current time is displayed on the displayed time display portion 25.

As an example, the EPG generating portion 181 has a structure in which the program column 23 corresponding to several hours shown in FIG. 10, that is, the EPG 2 shown in FIG. 10 is created and only an upper part thereof is displayed in the initial display as shown in FIG. 3. The EPG generating portion 181 displays only the upper part of the EPG 2 so that the user can select a program without disturbing program viewing.

Moreover, the EPG generating portion 181 creates three-dimensional EPG information. Consequently, it is possible to display, on the display screen 121, an image obtained by seeing the EPG 2 from above as shown in FIG. 5.

The EPG generating portion 181 has a structure in which the EPG 2 is initially displayed, and then, the created EPG 2 is further displayed wholly by the user interface module 116 or pressing the EPG key 117h of the remote controller 117.

### (Operation)

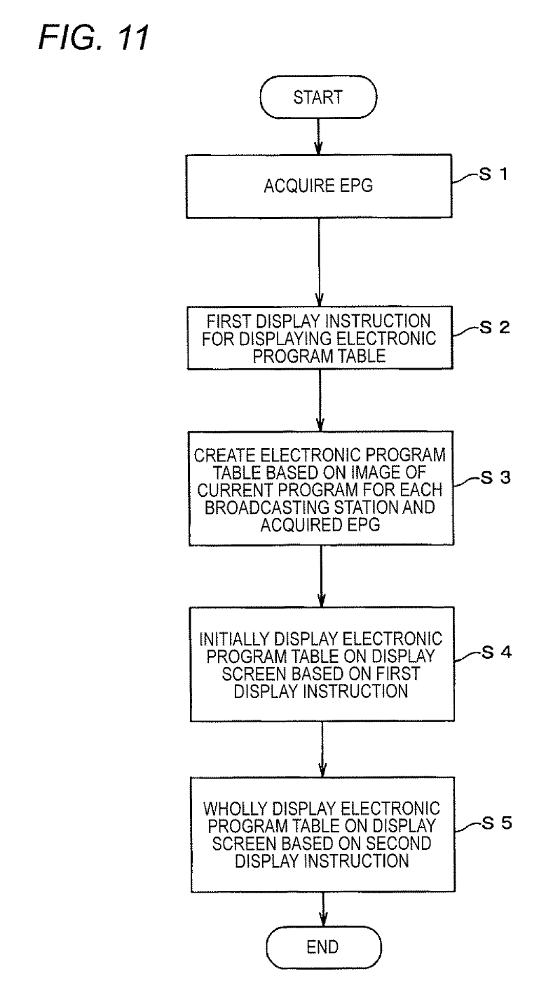

An operation related to the digital television according to the embodiment will be described below in detail in accordance with a flowchart of FIG. 11 with reference to each of the drawings. Description will be given to the case in which an instruction for displaying the EPG is given by the user.

The control module 156 of the digital television 1 controls the EPG information acquiring portion 180 based on a set cycle and acquires the EPG through the ground digital broadcast wave, the ground analog broadcast wave, the BS digital broadcast wave, the CS digital broadcast wave or the network (S1; acquiring step), and stores the EPG in the HDD 170.

Subsequently, the user presses the EPG key 117h of the remote controller 117 and gives an instruction for displaying the EPG (S2; display instruction step).

Then, the EPG generating portion 181 acquires an image of a program which is being broadcast every broadcasting station of the ground digital broadcast wave displayed initially, and creates the EPG 2 based on the image and the EPG acquired from the HDD 170 (S3; EPG generating step).

The EPG generating portion 181 transmits the created EPG 2 to the OSD signal generating module 154 as shown in FIG. 4, and the OSD signal generating module 154 transmits an OSD signal including information about the EPG 2 to the graphic processing module 152.

The graphic processing module 152 superposes and synthesizes a digital video signal output from the signal processing module 100 and the OSD signal and outputs a signal thus obtained to the video processing module 155.

The video processing module 155 converts the signal output from the video processing module 155 into an analog signal in a format which can be displayed by the display portion 120, and the display portion 120 displays the EPG 2 synthesized with the display image 122 as an initial display in a lower part of the display screen 121 (S4; first display step).

Next, the user further presses the EPG key 117h of the remote controller 117 and gives an instruction for displaying the EPG 2 in order to wholly display the EPG 2.

When inputting the instruction for a whole display through the light receiving module 118, the control module 156 outputs the display instruction to the EPG generating portion 181.

The EPG generating portion 181 provides the time display portion 25 on both sides of the EPG 2 based on the display instruction as shown in FIG. 8, and furthermore, hidden program information appears to be extended from the lower part of the display screen 121 toward the upper part thereof so that the EPG 2 is enlarged as shown in FIG. 9 and the date display portion 24 is displayed in the upper part of the display screen 121 as shown in FIG. 10. Thus, the EPG 2 is wholly displayed (S5; second display step).

Moreover, the user presses a predetermined one of the keys of the remote controller 117, thereby displaying the frame 20 for each broadcasting station of the hidden BS digital broadcast or CS digital broadcast as seen from above when a desirable program is not included in the displayed EPG 2.

The user can retrieve a program to be viewed or can set to record the program by seeing the display screen 121 shown in FIG. 10, for example, while repeating the operations.

### (Effect)

(1) According to the digital television 1, it is possible to see information about a program of another broadcasting station while seeing a program.
(2) According to the digital television 1, it is possible to see an image of a program of another broadcasting station which is being broadcast in addition to information about a program. Therefore, a high convenience can be obtained.
(3) According to the digital television 1, it is possible to see, as a dynamic image, a program of another broadcasting station which is being broadcast. Therefore, the convenience of a user can be further enhanced.
(4) According to the digital television 1, it is possible to create the thumbnail 21 of the EPG 2 even if a sufficient number of tuners are not provided.
(5) According to the digital television 1, it is possible to enlarge and display the EPG 2. Therefore, the user can easily select a program.
(6) According to the digital television 1, the upper part of the EPG 2 is displayed in the lower part of the display screen 121 in the initial display. Therefore, it is possible to prevent a program from being disturbed in viewing.
(7) According to the digital television 1, the EPG generating portion 181 can create three-dimensional EPG information in which the frame 20 for each broadcasting station is arranged concentrically every broadcasting format around the display image 122. Therefore, it is possible to carry out a display seen from above in accordance with a display instruction. Thus, it is possible to see program information about a larger number of broadcasting stations.
(8) According to the digital television 1, the frame 20 for each broadcasting station is arranged concentrically. Therefore, it is possible to see all of the frames 20 for the broadcasting stations by carrying out a scroll in a single direction. Consequently, a high convenience can be obtained.

The invention is not restricted to the embodiment but various modifications can be made without departing from or changing the technical thought of the invention.

As described with reference to the embodiment, there is provided an electronic apparatus and an EPG display method which can easily select a desirable program from a large number of channels having different broadcasting formats.

According to the embodiment, it is possible to easily select a desirable program from a large number of channels having different broadcasting formats.

What is claimed is:

1. An electronic apparatus comprising:
an electronic program guide (EPG) information receiver configured to receive EPG information; and
an EPG generating module configured to generate an EPG display image based on the EPG information,
wherein the EPG display image has a plurality of frames corresponding to channels, the frames being arranged in transverse and depth directions of the EPG display image and containing a thumbnail image and program information corresponding to the respective channels of the frame.

2. The apparatus of claim 1, wherein the frames are categorized in the depth direction by broadcasting formats.

3. The apparatus of claim 2 further comprising a user interface module,
wherein the EPG generating module is configured to control the EPG display image to be displayed on a display screen with channel names according to a first instruction input through the user interface module.

4. The apparatus of claim 3, wherein the EPG generating module is configured to enlarge a display region of the EPG display image on the display screen according to a second instruction input through the user interface module so as to display the program information about a subsequent time from the program information displayed by the first instruction.

5. The apparatus of claim 4, wherein the EPG generating module is configured to add a current date on the EPG display image displayed on the display screen according to the second instruction input through the user interface module.

6. The apparatus of claim 4, wherein the EPG generating module is configured to make the EPG display image displayed on the display screen into birds-eye view according to a third instruction input through the user interface module.

7. The apparatus of claim 6, wherein the EPG generating module is configured to control the EPG display image displayed on the display screen to laterally scroll the frames according to a fourth instruction input through the user interface module.

8. The apparatus of claim 7, wherein the EPG generating module is configured to categorize the frames by broadcasting formats according to a fifth instruction input through the user interface module.

9. The apparatus of claim 1, wherein the EPG generating module is configured to sequentially acquire an image of the program for each of the channels to set the thumbnail image on the EPG display image, when the program for each of the channels cannot be handled simultaneously.

10. An electronic apparatus comprising:
a user interface module;
an electronic program guide (EPG) information receiver configured to receive EPG information; and
an EPG generating module configured to generate an EPG display image based on the EPG information,
wherein the EPG display image has a plurality of frames corresponding to channels, the frames being arranged in transverse and depth directions of the EPG display image and containing a thumbnail image and program information corresponding to the respective channels of the frame,
wherein the EPG generating module is configured to control the EPG display image to be displayed on a display screen with channel names according to a first instruction input through the user interface module,
wherein the EPG generating module is configured to enlarge a display region of the EPG display image on the display screen according to a second instruction input through the user interface module so as to display the program information about a subsequent time from the program information displayed by the first instruction,
wherein the frames are categorized in the depth direction by broadcasting formats, and
wherein the EPG generating module is configured to make the EPG display image displayed on the display screen into birds-eye view according to a third instruction input through the user interface module.

11. An electronic program guide (EPG) display method comprising:
receiving EPG information;
generating an EPG display image based on the EPG information, the EPG display image having a plurality of frames corresponding to channels, the frames being arranged in transverse and depth directions of the EPG display image and containing a thumbnail image and program information corresponding to the respective channels of the frame;
displaying the EPG display image on a display screen with channel names when a first instruction is input;
enlarging a display region of the EPG display image on the display screen when a second instruction is input so as to display the program information about a subsequent time from the program information displayed by the first instruction.
